(19) United States
(12) Patent Application Publication
(10) Pub. No.: US 2026/0262661 A1
(43) Pub. Date: Sep. 10, 2026

(54) Dough-Based Inclusion for Dairy Products

(71) Applicant: General Mills, Inc., Minneapolis, MN (US)

(72) Inventors: Diana Lee Kittleson, Andover, MN (US); Christine Ng, Minneapolis, MN (US); Calen Nimmer, Saint Louis Park, MN (US); Andrea Young, Minneapolis, MN (US)

(73) Assignee: General Mills, Inc., Minneapolis, MN (US)

(21) Appl. No.: 19/162,477

(22) PCT Filed: Mar. 15, 2024
(86) PCT No.: PCT/US2024/020049

§ 371 Date: Sep. 5, 2025

Related U.S. Application Data
(60) Provisional application No. 63/452,214, filed on Mar. 15, 2023.
(60) Provisional application No. 63/470,540, filed on Jun. 2, 2023.

(51) Int. Cl. A21D 13/40; A21D 13/062; A23C 23/00; A23L 9/10; A23P 30/20

(52) U.S. Cl. CPC A21D 13/40; A21D 13/062; A23C 23/00; A23L 9/12; A23P 30/20

(57) ABSTRACT

A dough-based material (“dough inclusion”) is included within a dairy product to mimic the flavor and texture of a chewy baked good to provide a consumer with a novel eating experience. The dairy product can be yogurt, pudding, mousse, smoothies, frozen products like ice cream and frozen yogurt, liquid or solid premixes for frozen products, hand-held yogurt bites, and the like. The dough inclusion is tender (e.g., not dry or crumbly) and stable (e.g., generally retains its shape; does not disintegrate or become mushy/soggy) over the shelf life of the dairy product. In certain embodiments, the dough inclusion is an extruded product formed into dough pieces and a method of preparing the dairy product includes at least partially hydrating the dough pieces with a prep, then combining with a dairy material. In other embodiments, the dough pieces are separated from the prep prior to combining with the dairy material.

### FIELD OF THE INVENTION

The invention generally pertains to food and methods of making food. More particularly, the invention is related to a dough-based material for inclusion in dairy products (animal-derived or non-animal derived), as well as technology for preparing the dough-based inclusion and incorporating the dough-based inclusion with dairy products.

### BACKGROUND OF THE INVENTION

Many consumers enjoy a wide variety of dairy products, such as yogurt, pudding and the like. There is always demand for a diverse selection of dairy products, and food products in general. To meet such demand, food manufacturers attempt various combinations of flavors, colors and textures. One popular approach is to combine or facilitate (e.g., via packaging) the combination of a dairy material with a secondary food such as nuts, fruit, jam and/or chocolate sauce.

### SUMMARY OF THE INVENTION

A dough-based material (“dough inclusion”) is included within a dairy product to mimic the flavor and texture of a baked good, such as a brownie or a cookie, to provide a consumer with a novel eating experience. In some embodiments, the dairy product is a yogurt or a pudding, but can also include mousse, smoothies, frozen products like ice cream and frozen yogurt, liquid or solid premixes for frozen products, hand-held yogurt bites, and the like. The dough inclusion is tender (e.g., not dry or crumbly) and stable (e.g., generally retains its shape; does not disintegrate or become mushy/soggy) over the shelf life of the resulting dairy product. The flavor of the baked good comes through via ingredients within the dough inclusion added during its manufacture and/or via absorption by the dough inclusion of flavored liquids and/or syrups/sauces (e.g., chocolate sauce) included in a prep for the dairy product.

A dough inclusion for dairy products in accordance with the present invention includes flour and a sweetening agent. The dough inclusion can further include ingredients such as salt, oil, a binding agent, a flavoring agent and/or a coloring agent. In certain embodiments, the dough inclusion is retort- or pasteurization-stable so that it can be combined with a prep for the dairy product and then be retorted/pasteurized for sterilization purposes. In preferred embodiments, the dough inclusion is an extruded product.

A method of preparing a dough inclusion for dairy products in accordance with the present invention includes a step of preparing a dough mixture having flour and a sweetening agent and a step of shaping the dough mixture into one or more dough pieces. In preferred embodiments, the dough mixture is shaped via extrusion (e.g., twin screw extrusion with a shape-forming die). In some embodiments, the method of preparing the dough inclusion further includes drying the one or more shaped dough pieces to limit microbial growth, such as before the one or more pieces are combined with a prep to form a dough inclusion prep.

A dough inclusion prep for a dairy product in accordance with the present invention includes a dough inclusion and a prep. The dough inclusion is tender (e.g., not dry or crumbly) and stable (e.g., generally retains its shape; does not disintegrate or become mushy/soggy) over the shelf life of the dough inclusion prep (e.g., at least 90 days). Although, some change in shape (e.g., expansion) may occur.

A method of preparing a dough inclusion prep for a dairy product in accordance with the present invention includes a step of combining a dough inclusion with a prep. In some embodiments, combining a dough inclusion with a prep includes combining dough pieces with a prep and at least partially hydrating the dough pieces. In some embodiments, the method further includes drying the dough pieces before combining with the prep. In some embodiments, the method further includes retorting or pasteurizing (e.g., high moisture pasteurizing) the combination including the dough inclusion and the prep.

A dairy product in accordance with the present invention includes the dough pieces and a dairy material. The dough inclusion is tender (e.g., not dry or crumbly) and stable (e.g., generally retains its shape; does not disintegrate or become mushy/soggy) and delivers a chewy texture reminiscent of a baked good (e.g., brownies, cookies) over the shelf life of the dairy product (e.g., at least 60 days). Although, some change in shape (e.g., expansion) may occur. A method of preparing a dairy product in accordance with the present invention can include a step of combining a dough inclusion prep with a dairy material or first separating the dough pieces from the prep and then adding the dough pieces to the dairy material.

### DETAILED DESCRIPTION OF EMBODIMENTS

Initially, it should be noted that the embodiments of the present invention described below are not intended to be exhaustive or limit the invention to the precise forms disclosed in the following detailed description. Rather a purpose of the embodiments chosen and described is so that the appreciation and understanding by others skilled in the art of the principles and practices of the present invention can be facilitated.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

The term “dairy” refers to materials, compositions or products, based on or derived from, at least partially, animal milk (e.g., cow milk, sheep milk, goat milk, water buffalo milk, or bison milk, preferably cow milk) or non-animal milk ingredients (e.g., flour, starch or other plant-based materials). Non-animal milk ingredients can include ingredients produced by precision fermentation which involves programming simple microorganisms (e.g., using recombinant DNA technology or biomass or cellular fermentation) or molecular farming (e.g., production of proteins in higher order plants like legumes or leafy greens) to produce specific, desired organic molecules (e.g., proteins such as casein). Dairy products can include, e.g., yogurt, pudding, mousse, smoothies, frozen products including ice cream and frozen yogurt, liquid or solid premixes for frozen products, hand-held yogurt bites.

As used herein, “prep” refers to a preparation used to modify the taste, mouthfeel and/or texture of a dairy material, e.g., a fermented dairy material. A prep can include ingredients such as sweetening agents (e.g., sugar, sugar alcohols, allulose or sucralose), flavoring agents, coloring agents and stabilizers (e.g., guar gum). A prep typically does not contain dairy materials itself and is typically added to the dairy material as part of a last step in preparing a dairy-based product.

In connection with the invention, it has been discovered that a dough-based material can be included within a prep of a dairy product to mimic the flavor and texture of a baked good, such as a brownie or a cookie, to provide a consumer with a novel eating experience. In some embodiments, the dairy product is a yogurt or a pudding. The dough-based material (“dough inclusion”) is tender (e.g., not dry or crumbly) and stable (e.g., generally retains its shape; does not disintegrate or become mushy/soggy) over both the shelf life of the prep before it is added to the dairy material (e.g., at least 90 days or at least 100 days) and the shelf life of the resulting dairy product (e.g., at least 60 days), which has a water activity (Aw) of at least 0.85 (e.g., at least 0.97). The dough inclusion delivers a chewy texture reminiscent of a baked good over the shelf life of the dairy product. The flavor of the baked good comes through via ingredients within the dough inclusion added during its manufacture and/or via absorption by the dough inclusion of flavored liquids and/or syrups/sauces (e.g., chocolate sauce) included in the prep.

A dough inclusion for dairy products in accordance with the present invention includes flour and a sweetening agent. In preferred embodiments, flour is present in at least about 50 wt % of the dough inclusion. In some embodiments, the flour contains gluten (e.g., is a wheat flour). In preferred embodiments, the flour is gluten-free. For example, the gluten-free flour can include one or more of soy flour, rice flour, legume flour, tapioca starch and/or flour, or potato starch. In some embodiments, the flour has an amylose content over 20%.

In some embodiments, the gluten-free flour comprises glutamic acid, cystine, and proline. Such amino acids can enhance the gluten-free flour's ability to withstand retort/pasteurization (e.g., once the dough inclusion is mixed with a prep, to sterilize the dough inclusion prep). In some embodiments, a ratio of the glutamic acid in the gluten-free flour to an amount of glutamic acid in wheat flour is greater than about 0.75, a ratio of the cystine in the gluten-free flour to an amount of cystine in wheat flour is greater than about 0.85, and a ratio of the proline in the gluten-free flour to an amount of proline in wheat flour is greater than about 0.5. “Glutamic Acid in Wheat Flour” means about 4.86 dry weight percent glutamic acid, “Cystine in Wheat Flour” means about 0.34 dry weight percent cystine, and “Proline in Wheat Flour” means about 1.66 dry weight percent proline. These specific ratios of the particular amino acids may form high melt temperature peptides that provide structural support for the dough inclusion to help the dough inclusion withstand retort/pasteurization. In some embodiments, the gluten-free flour contains non-gluten protein and starch, which can also form a structural framework to support the dough inclusion during retort/pasteurization (e.g., see below regarding the formation of a bi-continuous matrix of protein and starch). The non-gluten protein can form about 15 wt % to about 35 wt % (e.g., at least about 18 wt %) of the gluten-free flour and the starch can be ungelatinized starch present as about 50 wt % to about 80 wt % of the gluten-free flour.

In preferred embodiments, the sweetening agent of the dough inclusion includes about 5 wt % to about 30 wt %, more preferably from about 5 wt % to about 20 wt %, and most preferably from about 10 wt % to about 15 wt %) sucrose by dry weight of the dough inclusion, or the sweetening equivalent thereof. The sweetening agent can include, e.g., one or more of glucose syrup, dried glucose syrup, brown sugar, molasses, honey, cane sugar (e.g., granulated or powdered sugar), beet sugar, maple syrup, agave syrup, concentrated juices or alternative sweeteners such as stevia, monk fruit, chicory root extract or sugar alcohols (preferably erythritol or mannitol).

The dough inclusion can further include ingredients such as salt, oil, a binding agent, a flavoring agent and/or a coloring agent. The binding agent can include, e.g., one or more of gluten or egg (e.g., egg whites), and can be included in amounts of up to 30 wt % (e.g., up to 15 wt %) of the dough inclusion. When present, the flavoring agent comprises from about 0.01 wt % to about 30 wt % (e.g., from about 10 wt % to about 15 wt %) of the dough inclusion. Bulky flavoring agents, like cocoa powder, fruit powders, etc., can be included in amounts of up to about 30 wt % (e.g., 10-15 wt %), while concentrated flavoring agents are preferably included at less than 5 wt %.

Preferably, the dough inclusion is retort- or pasteurization-stable so that it can be combined with a prep and then be retorted/pasteurized for sterilization purposes. In preferred embodiments, the dough inclusion is an extruded product. The dough inclusion can be of a variety of sizes and shapes. For example, the dough inclusion can be crumb-sized/shaped or the size/shape of gnocchi. In some embodiments, the dough inclusion further includes a filling (e.g., a chocolate sauce filling, ravioli-like) and/or ingredients that provides a crunchy texture.

A method of preparing a dough inclusion for dairy products in accordance with the present invention includes a step of preparing a dough mixture having flour and a sweetening agent. The flour and sweetening agent are described above with relation to the dough inclusion. The dough mixture can also include ingredients such as salt, oil, a binding agent, a flavoring agent and/or a coloring agent as described above. In some embodiments, preparing the dough mixture includes admixing water with the flour and sweetening agent.

The method of preparing the dough inclusion further includes shaping the dough mixture into one or more dough pieces. In preferred embodiments, the dough mixture is shaped via extrusion (e.g., twin screw extrusion with a shape-forming die). The extrusion can involve the addition of water and can be hot or cold but is preferably cold when the flour includes gluten and preferably hot when the flour is gluten-free. In some embodiments, e.g., when the flour is gluten-free, the extrusion includes extruding the dough mixture at a temperature and with an amount of mechanical energy effective to form one or more dough pieces having a bi-continuous matrix of protein and starch. Without wishing to be bound by any particular theory, some examples of a gluten-free dough inclusion according to the disclosure are believed to exhibit enhanced retort survivability (e.g., once the dough inclusion is mixed with a prep) by having a bi-continuous matrix of protein and starch that forms the structure of the dough inclusion. The bi-continuous matrix of protein and starch may be characterized by having continuous and semi-continuous phases of interconnected starch molecules dispersed among continuous and semi-continuous phases of interconnected protein molecules. Accordingly, instead of being formed primarily of discrete particles of intermixed protein and starch, the dough piece may instead have a networked structure formed of interwoven strands of protein and starch. The mechanical strength of this structure can provide a dough piece that survives retort while still exhibiting sufficient textual firmness even without having gluten protein to act as a binder and rigidity agent. Additionally or alternatively, the extruded dough pieces may have an external wall surface defined by a layer of gelatinized starch substantially devoid of pores, which may prevent starch and protein within the body of the wall structure from passing through the gelatinized starch layer during retort. Extruded dough pieces may alternatively be sheeted or formed into geometries that cannot be created using an extruder die head.

In some embodiments, the method of preparing the dough inclusion further includes drying the one or more shaped dough pieces. In some embodiments, drying the dough pieces includes drying the dough pieces to a moisture content of about 5% to about 15% (e.g., about 8% to about 11% or about 10% to 11%). Drying the one or more dough pieces is preferably done for cold-extruded pieces to limit microbial growth before, e.g., the one or more pieces are combined with a prep to form a dough inclusion prep.

In some embodiments, a shaped dough piece can be acidified prior to being combined with a prep. In some cases, a shaped dough piece can include an acidulent, such as a lemon juice, lactic acid, or citric acid in the formulation. Alternatively, or in combination with an acidulent included in a shaped dough piece, in some embodiments, a shaped dough piece can be pre-cooked in a dilute acid solution (e.g., lemon juice, lactic acid, or citric acid) before being combined with a prep.

A dough inclusion prep for a dairy product in accordance with the present invention includes a dough inclusion and a prep. In some embodiments, the prep contains fruit material. The prep can also or alternatively include, e.g., a flavored liquid or syrup/sauce (e.g., chocolate sauce) that is at least partially absorbed by the dough inclusion. The dough inclusion is tender (e.g., not dry or crumbly) and stable (e.g., generally retains its shape; does not disintegrate or become mushy/soggy) over the shelf life of the dough inclusion prep (e.g., at least 90 days or at least 100 days). Although, some change in shape (e.g., expansion) may occur. In some embodiments, the dough inclusion can exchange, e.g., water, color and/or flavor with the prep. The dough inclusion may also leach starch into the prep which could aid in thickening the dough inclusion prep.

A method of preparing a dough inclusion prep for a dairy product in accordance with the present invention includes a step of combining a dough inclusion with a prep. In some embodiments, combining a dough inclusion with a prep includes combining dough pieces with a prep and at least partially hydrating the dough pieces. In some embodiments, the method further includes drying the dough pieces (e.g., to a moisture content between about 5% and about 15%) before combining with the prep. At least partially hydrating the dough pieces (e.g., dried dough pieces) can increase the moisture content of the dough pieces by at least about 40% (e.g., between about 40% to about 55%). In some embodiments, the method further includes retorting or pasteurizing (e.g., high moisture pasteurizing, or high pressure cold pasteurization) the combination including the dough inclusion and the prep. Retorting/pasteurizing can also function to at least partially rehydrate the dough inclusion. The timing and/or temperature used during the retorting/pasteurizing can vary but preferably are sufficient to provide at least a 3 log E. coli reduction throughout, including at the center of the dough inclusion. In some embodiments, the combination including the dough inclusion and the prep is retorted or pasteurized at a temperature of 185 degrees Fahrenheit for about 5 minutes. The dough inclusion does not disintegrate or become mushy as a result of the retorting/pasteurizing. Retorting/pasteurizing is not necessarily required in instances where, e.g., the dough inclusion is made using hot extrusion. In some embodiments, the prep is retorted/pasteurized before being combined with the dough inclusion.

A dairy product in accordance with the present invention includes a dough inclusion prep and a dairy material. The dough inclusion is tender (e.g., not dry or crumbly) and stable (e.g., generally retains its shape; does not disintegrate or become mushy/soggy) and delivers a chewy texture reminiscent of a baked good (e.g., brownies, cookies) over the shelf life of the dairy product (e.g., at least 60 days). Although, some change in shape (e.g., expansion) may occur. Preferably, the dough inclusion exhibits a textural firmness. In some embodiments, the water activity of the dairy product is at least 0.85 (e.g., at least 0.97). In some embodiments, the dairy material is yogurt or pudding, although other embodiments are specified herein.

A method of preparing a dairy product in accordance with the present invention includes a step of combining a dough inclusion prep with a dairy material. The method can include holding the dough inclusion prep for up to 100 days before combining with the dairy material.

### EXAMPLES

Example 1—Dough inclusion formulations. Table 1 details exemplary formulations for the dough inclusion of the present invention. Cocoa powder was used as a flavoring. The ingredients were combined to form a dough mixture. The dough mixture was extruded to form noodle-shaped dough pieces and the noodle-shaped dough pieces were subjected to a pasteurization treatment (at a temperature of 185 degrees Fahrenheit for about 5 minutes). For each of the samples, some brown color from the cocoa powder was leached into the retort water but the noodle-shaped dough inclusions remained firm and intact and were chewy.

TABLE 1

| | | All Purpose | Powdered | Granulated | | Cocoa | | |
|---|---|---|---|---|---|---|---|---|
| # | Recipe | Flour (g) | Sugar (g) | Sugar (g) | Eggs (g) | powder (g) | Salt (g) | Oil (g) |
| 1 | 3.6% sugar, | 218.75 | 14 | 0 | 100 | 39.3 | 1.42 | 13.4 |
| | 10% cocoa | | | | | | | |
| 2 | 20% sugar, | 155.376 | 0 | 77.374 | 100 | 39.3 | 1.42 | 13.4 |
| | 10% cocoa | | | | | | | |
| 3 | 30% sugar, | 98.05 | 0 | 116 | 100 | 58 | 1.42 | 13.4 |
| | 15% cocoa | | | | | | | |
| 4 | 30% sugar, | 116.75 | 0 | 116 | 100 | 39.3 | 1.42 | 13.4 |
| | 10% cocoa | | | | | | | |
| 5 | 20% sugar, | 136.676 | 0 | 77.374 | 100 | 58 | 1.42 | 13.4 |
| | 15% cocoa | | | | | | | |

Although described with reference to certain preferred embodiment of the invention, it should be recognized that various changes and/or modifications can be made without departing from the invention. For instance, although the dough inclusion can be added with the prep to the dairy material, in some embodiments, the dough pieces can be combined with the prep to be at least partially hydrated and then separated from the prep before being incorporated into the dairy material, without the prep. The inclusion in ice cream is a good example of this variation wherein pre-pasteurization would not be needed, but rather the partially hydrated dough pieces, without a carry prep or variegate, can be metered or dosed into the dairy material, followed by, in the case of ice cream, pasteurization, churning and freezing. In some embodiments, the dough pieces are at least partially hydrated in a prep, without further combining the prep with another dairy matrix. Finally, in certain embodiments, the prep will be dairy free, while in other embodiments dairy can be in the prep.

1. A method of making a dough inclusion prep for dairy products, the method comprising
preparing a dough mixture including flour and a sweetening agent;
shaping the dough mixture into dough pieces; and
combining the dough pieces with a prep to form a dough inclusion prep, wherein combining the dough pieces with the prep includes at least partially hydrating the dough pieces.

2. The method of claim 1, further comprising, before combining the dough pieces with the prep, drying the dough pieces to form dried dough pieces having a moisture content between about 5% and about 15%, wherein combining the dough pieces with the prep includes combining the dried dough pieces with the prep and at least partially hydrating the dried dough pieces.

3. The method of claim 2, wherein at least partially hydrating the dried dough pieces increases the moisture content of the dried dough pieces by at least about 40%.

4. The method of claim 1, wherein shaping the dough mixture into one or more dough pieces includes extruding the dough mixture.

5. (canceled)

6. The method of claim 1, further comprising subjecting the combination of the dough pieces and the prep to retort or pasteurization, wherein the retort or pasteurization includes heating the combination to at least 185 degrees Fahrenheit for at least 5 minutes.

7. (canceled)

8. The method of claim 1, wherein the flour includes soy flour, rice flour, legume flour, tapioca starch and/or flour, potato starch, or a flour having an amylose content over 20%.

9. The method of claim 1, wherein the prep includes fruit material or sauce.

10. The method of claim 1, comprising wherein the dough mixture comprises an acidulent or the method further comprises cooking the dough pieces in an acid solution prior to combining the dough pieces with the prep.

11. (canceled)

12. The method of claim 1, further comprising preparing a dairy product from the dough inclusion prep, including combining the dough inclusion prep with a dairy material.

13. The method of claim 12 wherein, prior to combining with the dairy material, the dough inclusion prep is dairy free.

14. The method of claim 12 wherein, prior to combining with the dairy material, the dough inclusion prep includes dairy.

15. The method of claim 1, further comprising, after at least partially hydrating the dough pieces with the prep, separating the dough from the prep and preparing a dairy product by combining the dough pieces, without the prep, into a dairy material.

16. A dough inclusion prep prepared by the method of claim 1, wherein the dough pieces are stable over the shelf life of the dough inclusion prep.

17. The dough inclusion prep of claim 16, wherein the shelf life is at least 60 days.

18. The dough inclusion prep of claim 16, wherein the flour includes soy flour, rice flour, legume flour, tapioca starch and/or flour, potato starch or a flour having an amylose content over 20%.

19. The dough inclusion prep of claim 16, wherein the prep includes fruit material or sauce.

20. A dairy product prepared by the method of claim 12, wherein a water activity of the dairy product is at least 0.85 and the dough pieces exhibit a chewy texture.

21. The dairy product of claim 20, wherein the dairy material is selected from the group consisting of yogurt, pudding, mousse, smoothies, frozen products including ice cream and frozen yogurt, liquid or solid premixes for frozen products, and hand-held yogurt bites.

22. The dairy product of claim 21, wherein the dairy material is yogurt or pudding.

23. The dairy product of claim 20, wherein the dough pieces are stable over the shelf life of the dairy product.
